(19) United States
(12) Patent Application Publication
(10) Pub. No.: US 2016/0345570 A1
(43) Pub. Date: Dec. 1, 2016

(54) INSECT ENTRAPMENT APPARATUS AND RELATED METHODS OF USE

(71) Applicant: JOHN D. (JED) COPHAM, BRAINERD, MN (US)

(72) Inventor: JOHN D. (JED) COPHAM, BRAINERD, MN (US)

(21) Appl. No.: 15/164,242

(22) Filed: May 25, 2016

Related U.S. Application Data
(60) Provisional application No. 62/166,926, filed on May 27, 2015.

(51) Int. Cl. A01M 1/06; A01M 1/10

(52) U.S. Cl. CPC A01M 1/06; A01M 1/106; A01M 2200/012

(57) ABSTRACT

An insect entrapment apparatus is disclosed herein. In various aspects, the insect entrapment apparatus includes a bag formed of a mesh material having a mesh sized to pass airflow from an interior of the bag through the mesh while entrapping insects entrained within the airflow within the interior of the bag. The bag forms an enclosed interior with an entry to admit airflow into the interior of the bag, in various aspects. The bag, in various aspects, includes an elastic material disposed about the entry of the bag to grippably compressionably secure the entry to a housing of a fan assembly with the interior of the bag in fluid communication with the fan assembly. This Abstract is presented to meet requirements of 37 C.F.R. §1.72(b) only. This Abstract is not intended to identify key elements of the methods of use and related apparatus disclosed herein or to delineate the scope thereof.

### CROSS REFERENCE TO RELATED APPLICATIONS

This application claims priority and benefit of co-pending U.S. Provisional Patent Application No. 62/166,926 filed 27 May 2015, which is hereby incorporated by reference in its entirety herein.

### BACKGROUND OF THE INVENTION

Field

This disclosure relates to insect control, and, more particular, to apparatus and related methods for the capture of flying insects.

Related Art

Insect control in the outdoor environment, particularly at various outdoor public venues such as parks, stadiums, grandstands, ballparks, and racetracks, may be challenging. The use of insecticides to control insects, particularly biting or noxious flying insects such as flies and mosquitos, may pose various health risks. For example, certain people may be particularly sensitive to insecticide, so that exposure to insecticide may precipitate various allergic responses. Long term exposure or exposure to large quantities of insecticide may pose a risk of cancer or other disease. Furthermore, insecticides may damage the ecosystem, and insecticides may pose other undesirable consequences to the environment.

Accordingly, there is a need for improved apparatus as well as related methods for the control of insects in the outdoor environment.

### BRIEF SUMMARY OF THE INVENTION

These and other needs and disadvantages may be overcome by the apparatus and related methods of use disclosed herein. Additional improvements and advantages may be recognized by those of ordinary skill in the art upon study of the present disclosure.

An insect entrapment apparatus is disclosed herein. In various aspects, the insect entrapment apparatus includes a bag formed of a mesh material having a mesh sized to pass airflow from an interior of the bag through the mesh while entrapping insects entrained within the airflow within the interior of the bag. The bag forms an enclosed interior with an entry to admit airflow into the interior of the bag, in various aspects. The bag, in various aspects, includes an elastic band disposed about the entry of the bag to grippably compressionably secure the entry to a housing of a fan assembly with the interior of the bag in fluid communication with the fan assembly.

This summary is presented to provide a basic understanding of some aspects of the apparatus and methods disclosed herein as a prelude to the detailed description that follows. Accordingly, this summary is not intended to identify key elements of the apparatus and methods disclosed herein or to delineate the scope thereof.

### BRIEF DESCRIPTION OF THE DRAWINGS

FIG. 1 illustrates by perspective view an exemplary implementation of a insect entrapment apparatus;

FIG. 2A illustrates by perspective view an exemplary bag that forms a portion of the exemplary insect entrapment apparatus of FIG. 1;

FIG. 2B illustrates by magnified plan view portions of the exemplary insect entrapment apparatus of FIG. 1;

FIG. 3 illustrates by cut-away perspective view portions of the exemplary insect entrapment apparatus of FIG. 1;

FIG. 4 illustrates by side cross-sectional view portions of the exemplary insect entrapment apparatus of FIG. 1;

FIG. 5 illustrates by plan view portions of the exemplary insect entrapment apparatus of FIG. 1;

FIG. 6A illustrates by perspective view an exemplary bag that forms a portion of another exemplary insect entrapment apparatus.

FIGS. 6B, 6C, and 6D illustrate by plan view exemplary stages of formation of the exemplary bag component of the exemplary insect entrapment apparatus of FIG. 6A;

FIG. 7A illustrates by perspective view another exemplary insect entrapment apparatus including an exemplary bag;

FIG. 7B illustrates by perspective view the exemplary bag component of the exemplary insect entrapment apparatus of FIG. 7A; and,

FIGS. 7C and 7D illustrate by plan view exemplary stages of formation of the exemplary bag of FIGS. 7A and 7B.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof. Use herein of relative terms such as generally, about, approximately, essentially, may be indicative of engineering, manufacturing, or scientific tolerances such as ±0.1%, ±1%, ±2.5%, ±5%, or other such tolerances, as would be recognized by those of ordinary skill in the art upon study of this disclosure.

### DETAILED DESCRIPTION OF THE INVENTION

An insect entrapment apparatus is disclosed herein. In various aspects, the insect entrapment apparatus includes a bag that forms an enclosed interior with an entry to admit airflow into the interior of the bag. The bag is formed of a mesh material having a mesh sized to pass airflow from the interior through the mesh while entrapping insects entrained within the airflow within the interior, in various aspects. An elastic material disposed about the entry of the bag to grippably compressionably secure the entry to a housing of a fan assembly with the interior of the bag in fluid communication with the fan assembly.

The bag may be formed of various mesh materials having a mesh that allows airflow to pass through the mesh while entrapping insects entrained in the airflow within the interior of the bag. The mesh material may be, for example, fiberglass mesh, plastic mesh, or metal mesh, and the mesh may be sized to entrap insects of a desired type. In various implementations, the mesh material may be cellulose based. In various implementations, the mesh material may be cloth formed of natural fibers, synthetic fibers, or both natural and synthetic fibers, and the mesh material may be compliant and foldable. In various implementations, the mesh material may be cheesecloth and the cheesecloth may include cotton. In various implementations, the mesh material may be formed of cheesecloth and the cheesecloth may essentially comprise cotton. In various implementations, the mesh material may include 90-weight close weave fine cheesecloth. In various implementations, the mesh material may be biodegradable.

The insect entrapment apparatus may include a fan assembly that includes housing surrounding fan blades powered by an electric motor. The fan assembly may include a light to attract insect to the vicinity of the fan assembly where the insects may be sucked into the bag by entrainment in airflow generated by the fan blades of fan assembly. Various wheels, handles, controls, and so forth may be provided about the fan assembly that facilitate handling or operation of the insect entrapment apparatus including the bag, in various implementations.

Insects may include mosquitos, flies, no-see-ums (ceratopogonidae), gnats, and other biting or noxious flying insects. The insects may be vectors of various diseases such as dengue fever, malaria, zika fever, yellow fever, worms, parasites, and protozoan diseases, and the insect entrapment apparatus including the bag may be used for disease control by eliminating these vectors.

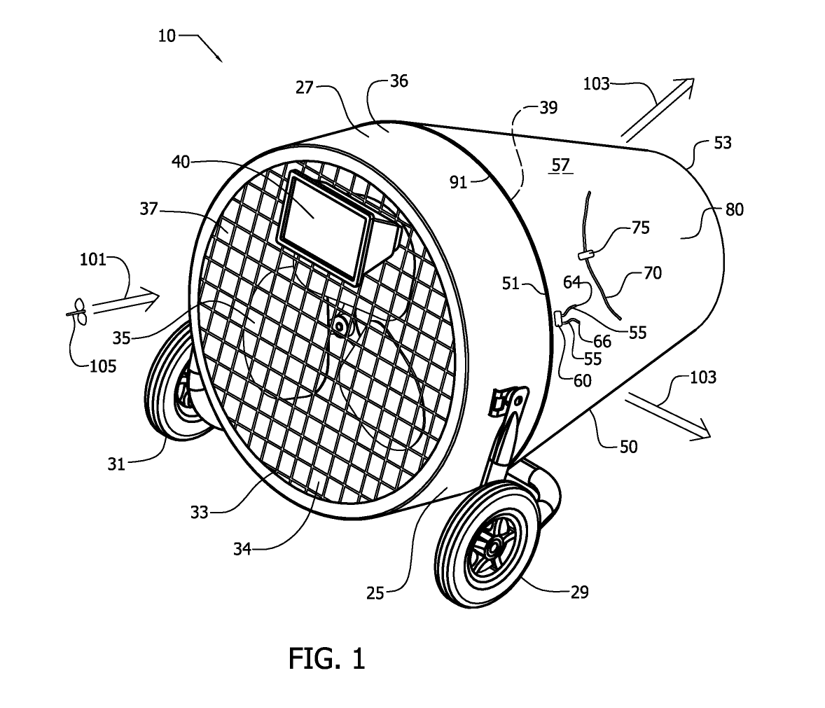

FIG. 1 illustrates an implementation of insect entrapment apparatus 10 that includes fan assembly 25, light 40, and bag 50. As illustrated in FIG. 1, fan assembly 25 includes housing 27 and fan blades 35, with fan blades 35 powered by an electric motor (not shown). When fan blades 35 are rotating under power, airflow, as indicated by arrow 101 in FIG. 1, is sucked into housing 27 by fan blades 35 from the exterior environment through entry 37 and then ejected out exit 39 of housing 27 into bag 50. Insects, such as insect 105, may be entrained in the airflow to be sucked into housing 27 and then ejected into bag 50 for capture in interior 57 of bag 50.

Fan assembly 25, in this implementation, includes grating 33 though which the airflow passes propelled by fan blades 35. Grating 33 encloses fan blades 35 to prevent objects larger than the aperture 34 of the grating 33 from engaging the fan blades 35 particularly when the fan blades 35 are rotating, in this implementation. Aperture 34 of grating 33 may be sized, in some implementations, to prevent large insects such as butterflies and moths from being sucked into fan assembly 25 through fan blades 35 and then into bag 50.

Fan assembly 25, in this implementation, includes wheels 29, 31 rotatably secured to housing 27 to allow fan assembly 25 to be positioned about. Note that the fan assembly 25, as illustrated in FIG. 1, is exemplary. Other implementations of fan assembly 25 may include, for example, various handles, wheels, grates, switches, controls, and may be configured in various ways, as would be readily understood by those of ordinary skill in the art upon study of this disclosure.

Light 40, as illustrated in FIG. 1, is positioned proximate entry 37 of housing 27 to attract insects, particularly flying insects, to the vicinity of the entry 37. Light 40 may be electrically powered, and may be hung onto housing 27 of fan assembly 25 to lie over portions of grating 33, as illustrated, or otherwise secured about fan assembly 25 generally proximate entry 37. Light 40 may variously emit light in the visible, ultraviolet, or infrared spectra as selected to attract selected insects.

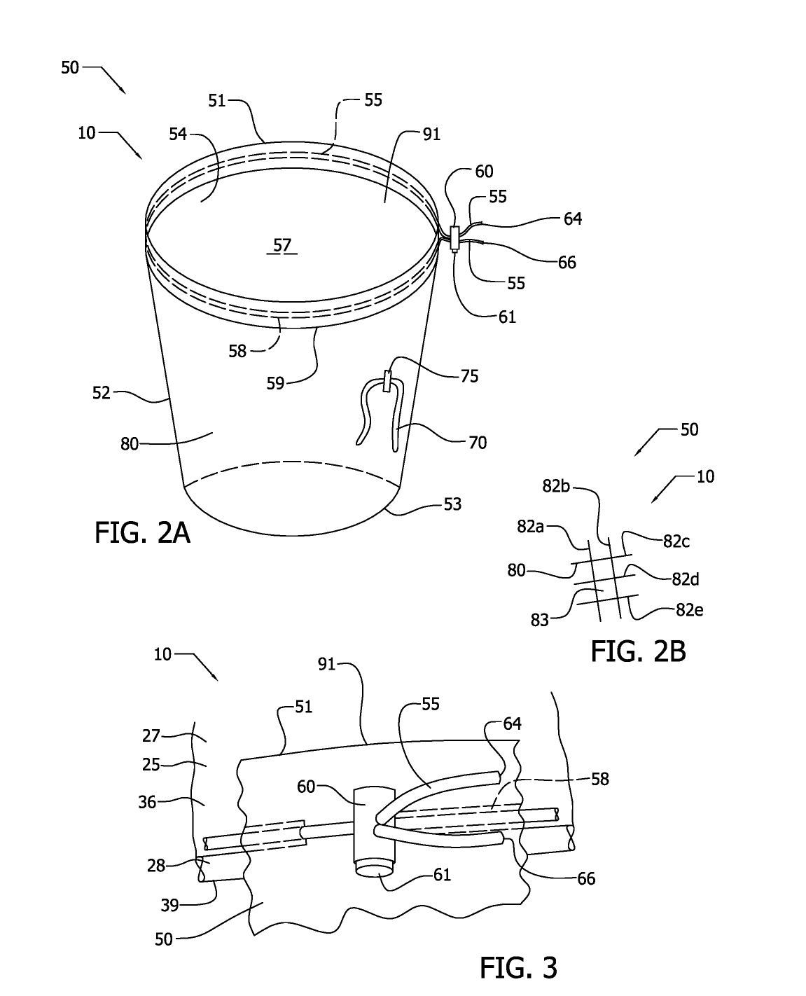

Bag 50 is secured to exit 39 of housing 27 of fan assembly 25 using cord 55 that is slidably secured within sleeve 58 (see FIG. 2) of bag 50 proximate end 51, as illustrated in FIG. 1. Bag 50 may be secured to exit 39 of housing 27 using various ties, hooks, fasteners, elastic material(s), or adhesive, in various implementations. Cord 55 may be a rope, strap, cord, or similar, and cord 55 may be formed of an elastic material. Cord 55 may be tensionably engaged with flange 28 (see FIG. 3) formed in housing 27 in order to secure removably bag 50 to exit 39 of housing 27. Flange 28, as illustrated, is located generally proximate exit 39 of fan assembly 25. Flange 28 may be formed as a flange, channel, ridge, chamfer, bevel, or other structure formed in housing 27 that may be engaged by cord 55. (See FIGS. 3 & 4) Clamp 60, as illustrated, releasably secures cord 55 in tension thereby securing cord 55 and, hence, bag 50 in tensioned removably secured engagement with housing 27 of fan assembly 25.

Cinch rope 70, which is attached to bag 50 by mount 75 in this implementation, may be used to tie off bag 50 to retain insects within the portion of the interior 57 of bag 50 generally proximate end 53 when bag 50 is removed from housing 27 of fan assembly 25.

As illustrated in FIG. 1, the fan blades rotating under power draw airflow along with insects attracted by the light through fan assembly 25, as indicated by arrow 101 and bag 50. The airflow passes through bag 50, as indicated by arrows 103, leaving the insects entrapped within interior 57 of bag 50.

FIG. 2A further illustrates bag 50 of insect entrapment apparatus 10. As illustrated in FIG. 2A, portions of bag 50 proximate end 51 are doubled back upon itself and hemmed with hem 59 to form sleeve 58. Cord 55 is slidably disposed within sleeve 58, as illustrated. Sleeve 58, in this implementation, extends circumferentially around bag 50 to allow the circumference of bag 50 at end 51 to be engaged with housing 27 of fan assembly 25 throughout the perimeter of housing 27 at exit 39 by cord 55. Note that the circumference of bag 50 at end 51 may be engaged with the perimeter of housing 27 in implementations of housing 27 having a square, rectangular, oval, or other shape.

Clamp 60 is releasably slidably engaged with cord 55 proximate ends 64, 66 of cord 55 as illustrated in FIG. 2A. Clamp 60 may be released allowing cord 55 to be slid through clamp 60 by pushing button 61. Release of button locks cord 55 in clamp 60. Sleeve 58 of bag 50 may be drawn about housing 27 and then locked to housing 27 to secure bag 50 to housing 27 by drawing ends 64, 66 of cord 55 away from sleeve 58 and then locking cord 55 with clamp 60. Sleeve 58 may be released from housing 27 to release bag 50 from housing 27 by releasing cord 55 from clamp 60. In other implementations, cord 55 may be knotted to position cord 55. Bag 50 may be secured to housing 27 by other mechanisms, for example, hook and loop fasteners, eyes, loops, hooks, or adhesive, in various implementations.

Bag 50, as illustrated in FIG. 2A, has a cylindrical shape, but may have other shapes in other implementations, such as in insect entrapment apparatus 100, 200 described herein. Interior 57 is defined by surface 54 of bag 50, and insects are collected within interior 57 when bag 50 is in use. End 53 of bag is enclosed by the mesh material 80 of bag 50, and end 51 of bag is open to form entry 91 into interior 57 of bag 50. Airflow may pass though the open end 51 of bag 50 into interior 57 of bag 50, while the airflow must pass through the mesh material 80 of bag 50 to exit bag 50 circumferentially, through end 53, or both circumferentially and through the mesh material 80 of end 53 thus entrapping insects within interior 57 of bag 50.

FIG. 2B illustrates exemplary mesh material 80 of bag 50. As illustrated in FIG. 2B, mesh material 80 is formed of threads 82a, 82b, 82c, 82d, 82e woven together and having mesh 83. In various implementations, the mesh 83 ranges is size from 0.01 mm to 1.6 mm.

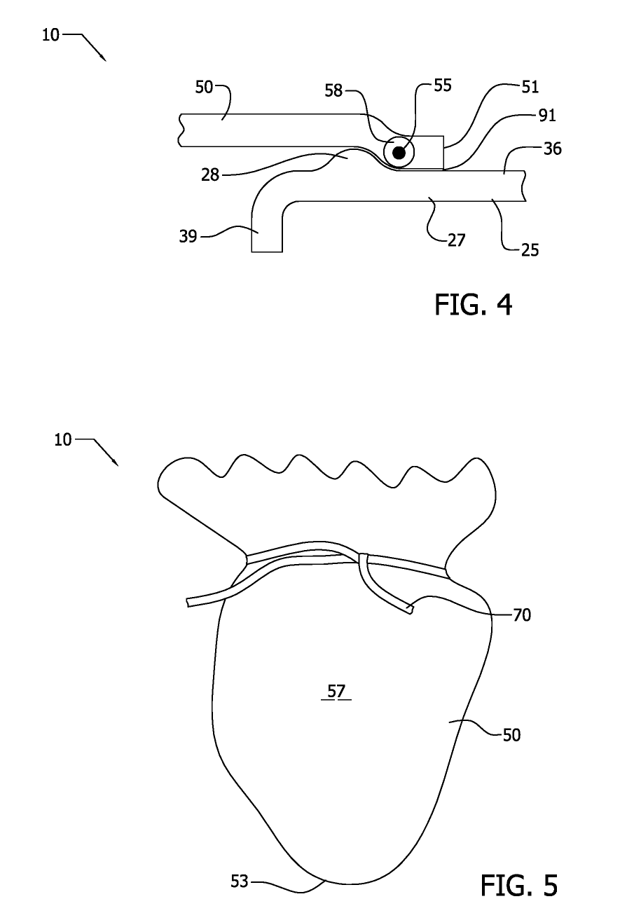

FIGS. 3 and 4 illustrate in detail the attachment of bag 50 to housing 27 of fan assembly 25. As illustrated in FIGS. 3 & 4, bag 50 is attached peripherally about exit 39 of housing 27. Cord 55, in this implementation, engages surface 36 including flange 28 of housing 27. Cord 55 is releasably held in tension against surface 36 including flange 28 by clamp 60 so that bag 50 is fixed to housing 27 when airflow passes through fan assembly 25 and through bag 50.

Cinch rope 70, which is attached to bag 50 by mount 75, may be used to enclose bag 50 to retain insects within the portion of bag 50 generally proximate end 53 when bag 50 is removed from housing 27. FIG. 5 illustrates bag 50 enclosed by cinch rope 70 to retain insects including other debris within the portion of interior 57 of bag 50 generally proximate end 53. Cinch rope 70, as illustrated, is wound circumferentially around bag 50 and then knotted to itself to enclose the interior 57 of bag 50 proximate end 53 to prevent the escape of insects from interior 57, for example, during removal of bag 50 from housing 27 of fan assembly 25. Cinch rope 70 may be made, for example, of nylon or cotton, and may be formed as a rope, strap, line, or other such securement. Cinch rope 70 passes through mount 75 that is formed as a rectangular strap secured to side 52 of bag 50. Mount 75 is illustrated as located approximately halfway between ends 51, 53 of bag 50, but mount 75 may be positioned closer to either of ends 51, 53 in other implementations. Chord 55 may be drawn to enclose interior 57 of bag 50, and cord 55 may then be secured, for example, by knot or by clamp, such as clamp 60. Clamp 60 may be omitted, in some implementations, and cord 55 may be knotted or otherwise secured.

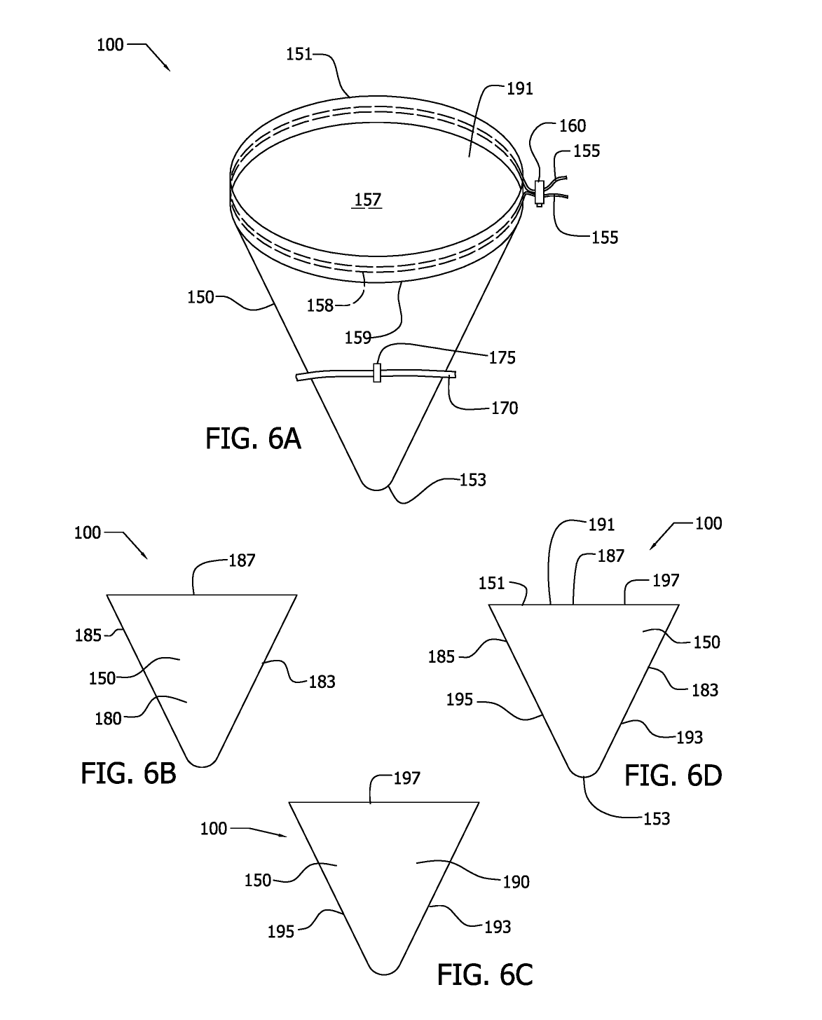

FIG. 6A illustrates exemplary insect entrapment apparatus 100 including exemplary bag 150. As illustrated in FIG. 6, cord 155 is slidably engaged within sleeve 158 of bag 150 at end 151. Hem 159 encloses sleeve 158, as illustrated. Sleeve 158, in this implementation, extends circumferentially around bag 150 to allow cord 155 to engage the circumference of bag 150 at end 151 with the perimeter of a housing, such as housing 27, of a fan assembly, such as fan assembly 25. Clamp 160 is releasably slidably engaged with cord 155, in the illustrated implementation.

Bag 150, as illustrated in FIG. 6A, has a conic shape that tapers from end 151 toward end 153, and end 153 of bag 150 is enclosed by the mesh material of bag 150. Insects are collected within interior 157. Airflow from a fan assembly, such as fan assembly 25, may pass though the open end 151 of bag 150 into interior 157 of bag 150, while the airflow must pass through the mesh material of bag 150 to exit bag 150 circumferentially, through end 153, or both circumferentially and through the end 153. The mesh material of bag 150 filters insects entrained within the airflow from the airflow entrapping the insects within bag 150. Cinch rope 170, which is attached to bag 150 by mount 175, may be used to enclose bag 150 to retain insects within the portion of bag 150 generally proximate end 153.

FIGS. 6B, 6C, and 6D illustrate an exemplary construction of bag 150. As illustrated in FIGS. 6B, 6C, pieces 180, 190 are generally triangular and conform to one another in size and shape. As illustrated in FIG. 6D, piece 180 is then overlain upon piece 190 and side 183 is seamed to side 193 and side 185 is seamed to side 195 to form bag 150. Sides 187, 197 are unattached to one another to form end 151 with entry 191, as illustrated in FIG. 6D. Sleeve 158, cord 155 and so forth may be formed or attached, as convenient.

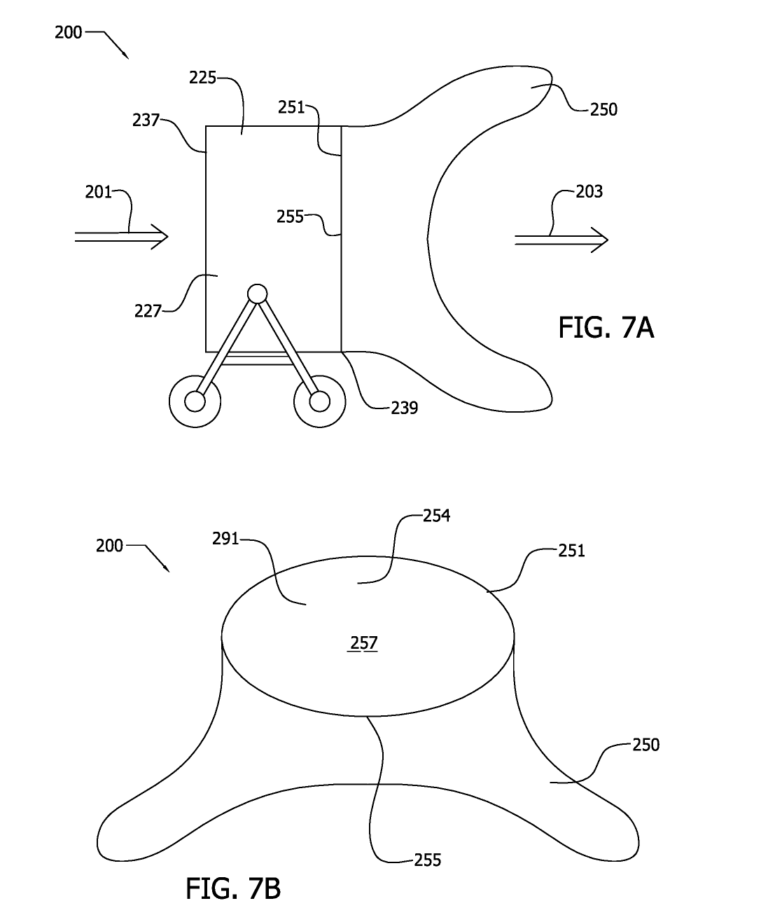

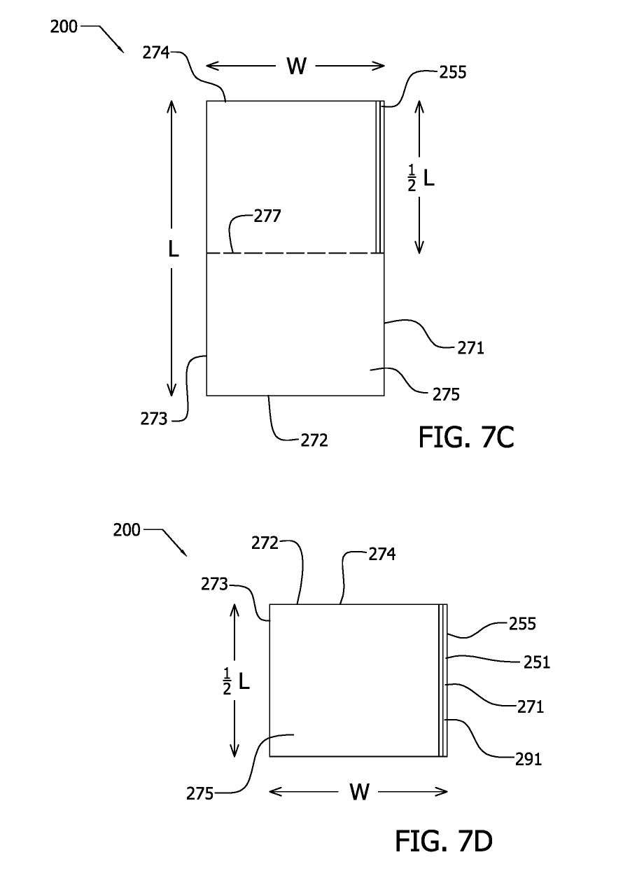

FIGS. 7A and 7B illustrated exemplary insect entrapment apparatus 200 including bag 250. As illustrated in FIG. 7A, bag 250 is secured to exit 239 of housing 227 of fan assembly 225. As illustrated in FIG. 7A, airflow along with insects entrained in the airflow is drawn through entry 237 of housing 227 if fan assembly 225, as indicated by arrow 201. The airflow exits fan assembly 225 passing through bag 250, as indicated by arrows 203, leaving the insects entrapped within interior 257 (see FIG. 7B) of bag 250. Bag 250 is secured to housing 227 via elastic band 255 disposed about at least portions of end 251 of bag 250. Elastic band 255 grippably compressionably releasably engages bag 250 with housing 227 proximate exit 239.

Bag 250, as illustrated in FIGS. 7A and 7B, has generally a crescent shape with a generally circular cross-section. Interior 257 of bag 250 is defined by surface 254 of bag 250, and insects are collected within interior 257 when bag 520 is in use. End 251 of bag 250 is open to form entry 291 into interior 257 of bag 250, as illustrated. Airflow may pass though entry 291 of bag 50 into interior 257 of bag 50, while the airflow must pass through the mesh material of bag 250 to exit bag 250 so that insects entrained within the airflow are captured within interior 257 by the mesh material of bag 250.

Bag 250 may be formed as illustrated in FIGS. 7C and 7D. At exemplary first stage of formation, illustrated in FIG. 7C, mesh material 275 from which bag 250 is formed is rectangular with length L and width W. Elastic band 255 is attached along portions of side 271 so that elastic band 255 extends along about half the length L of side 271, and side 271 may be gathered about elastic band 255. At exemplary second stage of formation illustrated in FIG. 7D, mesh material 275 is then folded in half (along dashed line 277 in FIG. 7C) so that side 272 meets side 274. Side 273 is then seamed to itself and sides 272, 274 are seamed to one another to form bag 250 that encloses interior 257, in this implementation. Side 271 including elastic 255 forms end 251 with entry 291, in this implementation. When deployed, bag 250 may have generally the crescent shape as illustrated in FIGS. 7A and 7B.

In operation, an end, such as end 51, 151, 251 of a bag, such as bag 50, 150, 250 may be secured to a housing, such as housing 27, of a fan assembly, such as fan assembly 25 using a cord, such as cord 55, 155, so that fan assembly ejects airflow into the entry, such as entry 91, 191, 291 of the bag. Alternatively, the end of the bag may be attached to the housing by an elastic band disposed about the end for that purpose. As a further alternative, the end of the bag may be attached to the housing by an adhesive strip disposed about the end for that purpose. With the bag secured to the housing, the insect entrapment apparatus, such as insect entrapment apparatus 10, 100, 200 attracts various insects, particularly flying insects such as insect 105, with a light, such as light 40. Then, the rotation of fan blades, such as fan blades 35, of the fan assembly under power sucks the insects, such as insect 105, entrained in the airflow through the fan assembly and into the bag though the entry. The mesh material that forms the bag is selected to allow airflow to pass through while straining the insects from the air. The mesh material may be formed as a mesh with size selected to capture certain selected insects including vectors of certain diseases. The insects are then entrapped within the interior, such as interior 57, 157, of the bag. The light 40 may attract various insects to be then entrained within the airflow.

A cinch rope, such as cinch rope 70, 170, may be used to enclose the interior of the bag in order to contain the entrapped insects within interior proximate the closed end, such as end 53, 153, of the bag. With insects contained within the interior of the bag by cinching of the bag with the cinch rope, the bag may be removed from the housing. The insects within the interior of the bag may be disposed of following removal of the bag from the housing. The cinch rope may be released to allow the insects to be dumped out of the bag. The bag may be reused multiple times, in various implementations. The cord may also be drawn to enclose the bag. In other implementations, the bag with the insects entrapped within may be disposed of and another bag affixed to the housing. In other implementations, the bag may be biodegradable and may be disposed of with insects entrapped within, for example, by landfill disposal or by internment in the ground in a garden or other agricultural setting.

The foregoing discussion along with the Figures discloses and describes various exemplary implementations. These implementations are not meant to limit the scope of coverage, but, instead, to assist in understanding the context of the language used in this specification and in the claims. Upon study of this disclosure and the exemplary implementations herein, one of ordinary skill in the art may readily recognize that various changes, modifications and variations can be made thereto without departing from the spirit and scope of the inventions as defined in the following claims.

The invention claimed is:

1. A apparatus for the entrapment of insects, comprising:
a bag that forms an enclosed interior with an entry to admit airflow into the interior of the bag, the bag formed of a mesh material having a mesh sized to pass airflow from the interior through the mesh while entrapping insects entrained within the airflow within the interior; and
elastic material disposed about the entry of the bag to grippably compressionably secure the entry to a housing of a fan assembly with the interior of the bag in fluid communication with the fan assembly.

2. The apparatus of claim 1, further comprising:
a cinch rope attached to the bag, the cinch rope used to enclose bag to contain the entrapped insects within interior proximate an enclosed end of the bag.

3. The apparatus of claim 1, wherein the mesh material comprises a biodegradable material.

4. The apparatus of claim 1, wherein the mesh material comprises cotton cheesecloth.

5. The apparatus of claim 4, the cotton cheesecloth being 90 weight close weave fine.

6. The apparatus of claim 1, wherein the mesh material comprises a fiberglass mesh.

7. The apparatus of claim 1, wherein the mesh ranges from 0.01 mm to 1.6 mm.

8. The apparatus of claim 1, the mesh material being of rectangular configuration that is folded and seamed to form the bag, at least in part.

9. The apparatus of claim 1, the mesh material comprising a sheet of triangular shape and a second sheet of triangular shape, the sheet and the triangular sheet being seamed together to form the bag, at least in part.

10. A apparatus for the entrapment of insects, comprising:
bag means to form an enclosed interior having an entry to admit airflow into the interior, said bag means comprised of a mesh material having a mesh sized to pass airflow from the interior through the mesh while entrapping insects entrained within the airflow within the interior; and
securement means disposed about the entry of the bag means to secure said bag means to a fan assembly with the interior in fluid communication with the fan assembly.
